(19) United States
(12) Patent Application Publication
(10) Pub. No.: US 2025/0320838 A1
(43) Pub. Date: Oct. 16, 2025

(54) ENGINE CONTROL METHOD, ENGINE, VEHICLE, AND COMPUTER-READABLE STORAGE MEDIUM

(71) Applicant: BYD COMPANY LIMITED, Shenzhen (CN)

(72) Inventors: Shiyi PAN, Shenzhen (CN); Guanting LI, Shenzhen (CN); Jing LIU, Shenzhen (CN)

(21) Appl. No.: 19/246,937

(22) Filed: Jun. 24, 2025

Related U.S. Application Data
(63) Continuation of application No. PCT/CN2023/104896, filed on Jun. 30, 2023.

(30) Foreign Application Priority Data
Dec. 30, 2022 (CN) 202211731103.6

(51) Int. Cl. F02D 35/02; F02B 77/11

(52) U.S. Cl. CPC F02D 35/025; F02B 77/11

(57) ABSTRACT

An engine control method comprises: acquiring a characterizing temperature characterizing the temperature in a combustion chamber; and when an engine is in a compression stroke, controlling, according to a preset rule, a fuel injection system to inject fuel into the combustion chamber, wherein the fuel in the combustion chamber is heated and spontaneously combusted, and input parameters of the preset rule comprise the characterizing temperature.

### CROSS-REFERENCE TO RELATED APPLICATIONS

The present application is a continuation application of PCT application No. PCT/CN2023/104896, filed on Jun. 30, 2023, which claims priority to Chinese Patent Application No. 202211731103.6, filed on Dec. 30, 2022 and entitled “CONTROL METHOD FOR ENGINE, ENGINE, VEHICLE, AND COMPUTER-READABLE STORAGE MEDIUM”. The entire content of all of the above-referenced applications is incorporated herein by reference.

### FIELD

The present disclosure relates to the technical field of engines, and more specifically, to a control method for an engine, an engine, a vehicle, and a computer-readable storage medium.

### BACKGROUND

In the related art, during operation of a fuel engine, a gas mixture at an end of the engine combusts earlier due to impact of a temperature and a pressure of a main combustion chamber and a wall temperature. The generated pressure wave interacts with a pressure wave of the main combustion chamber, which generates a knock. Therefore, a new technical solution is required to resolve the foregoing problem.

### SUMMARY

The present disclosure is intended to provide a control method for an engine, an engine, a vehicle, and a computer-readable storage medium.

According to a first aspect of the present disclosure, a control method for an engine is provided. The control method includes the following steps. A characterizing temperature characterizing a temperature in a combustion chamber is obtained. A fuel injection system is controlled to inject fuel into the combustion chamber according to a preset rule when an engine is in a compression stroke. The fuel in the combustion chamber is heated and spontaneously combusts. An input parameter of the preset rule includes the characterizing temperature.

According to a second aspect of the present disclosure, a computer-readable storage medium is provided, which stores computer instructions. The computer instructions, when executed by a processor, perform the foregoing control method for an engine.

According to a third aspect of the present disclosure, an engine is provided. The engine includes an engine body, a fuel injection system, a piston, and a control apparatus. A cylinder is formed in the engine body. The piston is slidably arranged in the cylinder. A combustion chamber is formed between the piston and an inner wall of the cylinder. The fuel injection system is connected with the combustion chamber and configured to inject fuel into the combustion chamber. The control apparatus is configured to: obtain a characterizing temperature characterizing a temperature in a combustion chamber; and control, according to a preset rule, a fuel injection system to inject fuel into the combustion chamber when an engine is in a compression stroke, the fuel in the combustion chamber being heated and spontaneously combusting, and an input parameter of the preset rule including the characterizing temperature.

According to a fourth aspect of the present disclosure, a vehicle is provided. The vehicle includes a vehicle body and the foregoing engine. The engine is arranged on the vehicle body.

In embodiments of the present disclosure, a combustion mode of heating the fuel to spontaneous combustion is adopted. When the engine is in the compression stroke, the fuel is injected from a fuel injection nozzle and then gradually mixes with the air and is heated up. Flame in the combustion chamber starts to combust from an end (that is, an end close to a piston) of a fuel injection beam and gradually spreads upward. That is, the combustion mode of heating and spontaneous combustion fundamentally avoids a knock.

Through detailed description of exemplary embodiments of the present disclosure with reference to the following drawings, other features and advantages of the present disclosure become clear.

### BRIEF DESCRIPTION OF THE DRAWINGS

Drawings that are incorporated into and constitute a part of the specification illustrate embodiments of the present disclosure, and are used to explain the present disclosure together with the description thereof.

FIG. 1 is a flowchart of a control method for an engine according to an embodiment of the present disclosure;

FIG. 2 is a partial sectional view of an engine according to an embodiment of the present disclosure; and

FIG. 3 is a partial sectional view of another engine according to an embodiment of the present disclosure.

In the drawings: 100. Engine body; 101. Cylinder; 102. Combustion chamber; 103. Cylinder liner; 104. Piston; 105. Fuel injection nozzle; 106. Intake system; 107. Exhaust system; 108. Control apparatus; 109. Cooling apparatus; 110. Spark plug; 111. Temperature sensor; 113. Thermal insulation coating.

### DETAILED DESCRIPTION

Various embodiments of the present disclosure are described in detail with reference to drawings. It should be noted that unless otherwise specified, opposite arrangement, numerical expressions, and numerical values of components and steps described in the embodiments do not limit the scope of the present disclosure.

The following descriptions of at least one embodiment are merely illustrative, and in no way constitute any limitation on the present disclosure and application or use thereof.

Technologies, methods, and devices known to a person of ordinary skill in the related art may not be discussed in detail, but where appropriate, the techniques, the methods, and the devices should be considered as part of the specification.

In all examples shown and discussed herein, any specific value should be construed as merely examples and not as limitations. Therefore, other examples of exemplary embodiments may have different values.

It should be noted that similar reference numerals and letters denote similar items in the drawings below. Therefore, once an item is defined in a drawing, the item may not be further discussed in subsequent drawings.

The control method for an engine provided in the embodiments of the present disclosure is described in detail below by using a gasoline engine as an example. A person skilled in the art may learn that the control method for an engine provided in the embodiments of the present disclosure may further be applied to an engine with another fuel, such as natural gas, methanol, and ethanol.

In the related art, a larger compression ratio of an engine indicates a higher risk of knock. A larger compression ratio indicates a larger pressure in a combustion chamber, and a gas mixture at an end is easier to spontaneously combust. Therefore, the engine has a higher risk of knock. Therefore, limited by the risk of knock, a compression ratio of a quantitative gasoline engine can generally only be set below 15. However, thermal efficiency of the engine is related to the compression ratio. A larger compression ratio indicates higher thermal efficiency. Therefore, the thermal efficiency of the quantitative gasoline engine in the related art can only reach approximately 40%.

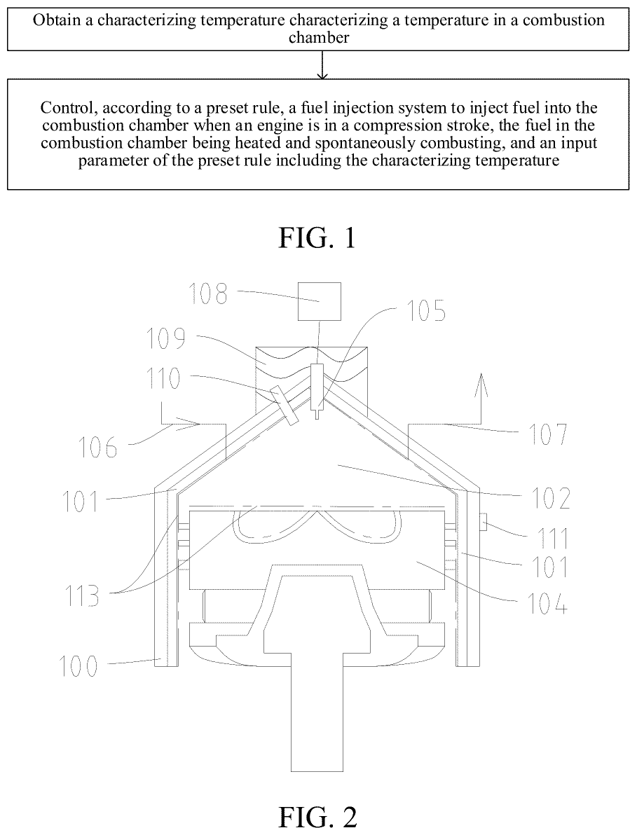

According to an embodiment of the present disclosure, a control method for an engine is provided. As shown in FIG. 1, the control method includes the following steps.

A characterizing temperature characterizing a temperature in a combustion chamber 102 is obtained.

When an engine is in a compression stroke, a fuel injection system is controlled to inject fuel into the combustion chamber 102 according to a preset rule. The fuel in the combustion chamber 102 is heated and spontaneously combusts. An input parameter of the preset rule includes the characterizing temperature.

The so-called spontaneous combustion in the present disclosure means that the fuel spontaneously combusts. Conditions required for the spontaneous combustion include a fuel concentration, a comburent, and a temperature reaching a spontaneous combustion temperature or above. In the related art, an engine typically ignites the fuel in the combustion chamber through a spark plug. The so-called spontaneous combustion in the present disclosure means that the fuel combusts under an action of a high-temperature point such as a spark or an electric arc.

In the present disclosure, a combustion mode of heating the fuel to spontaneous combustion is adopted. When the engine is in the compression stroke, the fuel is injected from a fuel injection nozzle 105 and then gradually mixes with the air and is heated up. Flame in the combustion chamber 102 starts to combust from an end (that is, an end close to a piston 104) of a fuel injection beam and gradually spreads upward. Essentially, the combustion mode of heating and spontaneous combustion fundamentally avoids a knock.

For example, a characterizing temperature characterizing a temperature in the combustion chamber 102 is obtained. During a compression stroke, when the characterizing temperature reaches a set value, the fuel injection system is controlled to inject the fuel into the combustion chamber 102, thereby causing the fuel to spontaneously combust. The control method can accurately control the fuel injection system to inject the fuel, thereby ensuring that the fuel sufficiently combusts.

In addition, before the fuel injection system injects the fuel into the combustion chamber 102, the temperature in the combustion chamber 102 reaches a set threshold, and combustion is performed by the spontaneous combustion of the fuel. In this way, a phenomenon of knock of the engine generated in a manner of ignition by a spark plug 110 can be effectively avoided, so that the engine is started more smoothly.

When the control method for an engine of this embodiment of the present disclosure is applied to a gasoline engine, a risk of knock of the gasoline engine at a high compression ratio can be effectively avoided. The compression ratio of the gasoline engine can be increased to above 15. Theoretically, a gasoline engine to which the control method for an engine of this embodiment of the present disclosure is applied can achieve a compression ratio of 18 or even above 20.

Specifically, as shown in FIG. 2, a temperature sensor 111 is arranged on an engine. The temperature sensor 111 is configured to obtain a characterizing temperature characterizing a temperature in a combustion chamber 102. For example, the characterizing temperature is a temperature of a defined position. A defined position closer to the combustion chamber 102 has a temperature closer to that in the combustion chamber 102.

When the engine is in a compression stroke, the piston 104 moves from a bottom dead center to a top dead center. In this process, mechanical energy is converted into internal energy. During the compression stroke, the fuel injection system is controlled to inject the fuel into the combustion chamber 102. Because the temperature in the combustion chamber 102 reaches a set threshold, the fuel is heated and spontaneously combusts under the condition. The spontaneously combusting fuel generates a large amount of gas, to push the piston 104 to move from the top dead center to the bottom dead center. Therefore, during a work stroke, a crank is driven by the piston 104 to rotate, thereby converting the internal energy into mechanical energy.

The preset rule is a rule for controlling the engine to inject fuel so that the fuel can spontaneously combust. It may be determined, according to an input parameter, whether the input parameter satisfies a relevant condition. Then, a result indicating whether to inject fuel, an amount of injected fuel, a fuel injection moment, a fuel injection frequency, and the like is outputted. The preset rule may be preset according to a compression ratio of the engine, a type of the fuel, an operating parameter of the engine, and the like.

For example, the input parameter of the preset rule includes the characterizing temperature characterizing the temperature in the combustion chamber. A determining condition for the characterizing temperature is to determine whether the characterizing temperature is greater than a set temperature. If yes, a result of injecting the fuel is outputted. If no, a result of not injecting fuel is outputted. When the characterizing temperature is equal to the set temperature, it indicates that the temperature in the combustion chamber 102 reaches the set threshold. Under the set threshold, the temperature in the combustion chamber 102 can reach a spontaneous combustion temperature of the fuel during the compression stroke, so that the fuel can be heated and spontaneously combust.

During actual operation of the engine, the engine in this embodiment of the present disclosure has a first operating state (also referred to as a warm-up state, a warm-up stage, or a first operating stage) and a second operating state (also referred to as a non-warm-up state, a non-warm-up stage, or a second operating stage) between which the engine can be switched. The control method for an engine in this embodiment of the present disclosure includes the following steps. The temperature in the combustion chamber 102 of the engine is increased to the set threshold during the first operating state. When the temperature in the combustion chamber 102 is greater than or equal to the set threshold, the temperature in the combustion chamber 102 can reach the spontaneous combustion temperature of the fuel during the compression stroke. The fuel is injected into the combustion chamber 102 during the second operating state, so that the fuel is heated and spontaneously combusts in the combustion chamber 102.

That a characterizing temperature characterizing a temperature in a combustion chamber 102 is obtained may be performed during the first operating state or during the second operating state. The fuel injection system is controlled to inject fuel into the combustion chamber according to the preset rule when the engine is in the compression stroke. The fuel in the combustion chamber 102 is heated and spontaneously combusts, which occurs during the second operating state.

It should be noted that the warm-up state and the non-warm-up state in this embodiment of the present disclosure are different from a warm-up state and a non-warm-up state in the related art. In the related art, a period of time in which components of the engine are increased to a temperature at which the components have relatively high operating efficiency after the engine is started is generally referred to as an engine warm-up or preheating period. Generally, during the compression stroke, the temperature in the combustion chamber 102 can only reach a temperature below 250° C., and usually can only reach a temperature below 200° C. In this embodiment of the present disclosure, a warm-up stage in which the temperature in the combustion chamber 102 of the engine rises approximately to 300° C. or 400° C. during the compression stroke is referred to as the warm-up state, to ensure that the fuel can enter the combustion chamber 102 in the non-warm-up state and can be heated and spontaneously combust.

It should be noted that impact of a high temperature on strength of the engine body may be overcome in multiple manners. For example, the engine body is arranged as an integral engine body, or the engine body is formed by using a material having a higher heat resistance, or a thermal insulation structure is arranged outside the combustion chamber 102, to reduce outward heat radiation of the combustion chamber 102. A specific manner may be adaptively selected by a person skilled in the art according to an actual situation under the guidance of this embodiment of the present disclosure.

In the warm-up state, the temperature in the combustion chamber 102 has not reached the set threshold. Therefore, in this case, a result outputted by the preset rule is that the fuel is not injected. In other words, in this case, the fuel cannot achieve spontaneous combustion in the combustion chamber 102. The preset rule is not met. In the warm-up state, the fuel injection system may inject the fuel under an action of another rule. For example, to ensure a consistent power output, in the control method for an engine of this embodiment of the present disclosure, the combustion chamber 102 can be heated while the engine is controlled to normally ignite the fuel normally with the spark plug, so as to implement normal operation of the engine.

In the non-warm-up state, in this case, the fuel can implement spontaneous combustion in the combustion chamber 102. The preset rule is met. According to the preset rule, the fuel injection system is controlled to inject the fuel into the combustion chamber 102. The fuel in the combustion chamber 102 is heated and spontaneously combusts.

It should be noted that the spontaneous combustion temperature of the fuel in this embodiment of the present disclosure refers to a spontaneous combustion temperature of the fuel in a current state in the combustion chamber 102, which is related to factors such as a pressure, a temperature, an air volume, and a fuel volume in the combustion chamber 102. The spontaneous combustion temperature may be obtained through real-time calculation after collecting related data, or may be obtained by calibrating spontaneous combustion temperatures in various operating conditions through a table, and querying content of the table.

Multiple manners of controlling the engine to switch between the warm-up state and the non-warm-up state exist. For example, according to the control method for an engine in this embodiment of the present disclosure, the operating state of the engine may be switched according to an operating time of the engine. For example, when the engine is started, the warm-up state is entered by default. The engine is controlled to enter the non-warm-up state after the engine is started and operated for a set time. After the engine is started and operated for a set time, the temperature in the combustion chamber 102 increases to the set threshold. In this case, it is considered that the warm-up is completed. The set time is related to a heating rate of the combustion chamber 102. A faster heat-up of the combustion chamber 102 indicates a shorter set time; otherwise, a longer set time. The set time may be calibrated by collecting actual operating data of the engine.

In the control method for an engine in this embodiment of the present disclosure, the operating state of the engine may further be switched according to the temperature in the combustion chamber 102. For example, the characterizing temperature characterizing the temperature in the combustion chamber 102 is obtained. When the characterizing temperature is the set temperature, it indicates that the temperature in the combustion chamber 102 is the set threshold. When the characterizing temperature is less than the set temperature, the engine enters the warm-up state to operate. When the characterizing temperature is greater than or equal to the set temperature, the engine enters the non-warm-up state to operate.

When the engine is in the warm-up state, the characterizing temperature is obtained at a first frequency.

When the engine enters the non-warm-up state to operate, the characterizing temperature characterizing the temperature in the combustion chamber 102 may be selected to be no longer obtained. The engine remains in the non-warm-up state to operate before the engine is stopped. Alternatively, the characterizing temperature characterizing the temperature in the combustion chamber 102 may be obtained again at a second frequency. In addition, it is determined whether the engine needs to be entered into the warm-up state again or whether the combustion chamber 102 needs to be maintained in the non-warm-up state for heating. The second frequency may be less than the first frequency. In the control method for an engine of this embodiment of the present disclosure, during the non-warm-up state, when the characterizing temperature is less than the set temperature, the temperature in the combustion chamber 102 of the engine is increased to the set threshold, so as to ensure that when the combustion chamber 102 of the engine cools down, the combustion chamber can be reheated to a temperature greater than the set threshold in time.

Optionally, the input parameter of the preset rule further includes at least one of a compression ratio of the engine, a crank angle of the engine, a camshaft phase of the engine, a rotation speed of the engine, a pressure value in the combustion chamber 102, an intake air flow of the combustion chamber 102, an amount of fuel injected from the combustion chamber 102, and a type of the fuel. Under a condition that the preset rule is met, the fuel injection system injects the fuel into the combustion chamber 102, so that the fuel is heated and spontaneously combusts in the combustion chamber 102.

The compression ratio indicates a degree to which gas in the cylinder 101 is compressed when the piston 104 is moved from the bottom dead center to the top dead center. For example, the compression ratio is a ratio of a total volume of the cylinder 101 before compression to a volume of the cylinder 101 after compression.

A larger rotation speed of the engine indicates a higher frequency of injecting the fuel. For example, in a four-stroke engine, for every two rotations of a crank, the combustion chamber 102 completes one combustion and a fuel injection nozzle injects one fuel. In other words, a fuel injection frequency is equal to a half of a rotation speed.

The pressure value in the combustion chamber 102 is related to parameters such as a compression ratio, an intake air flow, an exhaust gas flow, an amount of injected fuel, and a temperature. In the present disclosure, considering the pressure value in the combustion chamber 102 actually comprehensively considers the parameters such as the compression ratio, the intake air flow, the exhaust gas flow, the amount of injected fuel, and the temperature in the combustion chamber.

The intake air flow and the exhaust gas flow are related to the amount of injected fuel. A larger intake air flow and a larger exhaust gas flow indicate a larger amount of injected fuel.

A higher fuel injection pressure indicates a faster fuel injection velocity. The fuel can quickly enter the combustion chamber and be heated. In addition, a higher fuel injection pressure indicates a wider selection range of fuel injection timing.

The camshaft phase of the engine and the crank angle of the engine are used for controlling timing of opening and closing of an intake valve and/or an exhaust valve of the engine. The camshaft phase refers to a rotation phase in which multiple cams on the camshaft open and close the intake valve and/or the exhaust valve. The crank angle refers to an angle of rotation of the crank. The crank and camshaft may be synchronously rotated by a timing mechanism. By controlling the camshaft phase of the engine or the crank angle of the engine, the timing of opening and closing of the intake valve and/or the exhaust valve of the engine can be effectively controlled, so that the operating efficiency of the engine is higher. The rotation speed of the engine is a rotation speed of the crank.

Different types of the fuel and different fuel injection pressures indicate different spontaneous combustion temperatures. The types of the fuel may be gasoline, natural gas, methanol, ethanol, and the like. A fuel injection pressure value may be determined according to the compression ratio, the intake air flow, and the amount of injected fuel.

The foregoing description of the preset rule is merely an example. In a specific working process, under the guidance of the present disclosure, a person skilled in the art may specifically set types of the input parameters of the preset rule, and correspondingly set a determining condition corresponding to the input parameters, so as to correspondingly output a result.

In an example, that a characterizing temperature characterizing a temperature in a combustion chamber 102 is obtained includes the following step. A temperature at a defined position in an engine body 100 of the engine is obtained. A distance between the defined position and the combustion chamber 102 ranges from 4 mm to 10 mm.

For example, the engine body 100 is a metal material, such as carbon steel, stainless steel, and cast iron. The metal material transfers heat rapidly. The temperature sensor 111 is arranged at a defined position of the engine body 100. A defined position closer to the combustion chamber 102 indicates a temperature sensed by the temperature sensor 111 closer to the temperature in the combustion chamber 102. Within the foregoing size range, it may be ensured that the characterizing temperature obtained by the temperature sensor 111 is closer to the temperature in the combustion chamber 102.

In an example, the engine in this embodiment of the present disclosure may be provided with a cooling water jacket, to cool the combustion chamber 102. After the cooling water jacket is arranged, the combustion chamber 102 has an outer wall. That a characterizing temperature characterizing a temperature in a combustion chamber 102 is obtained includes the following step. A temperature of the outer wall of the combustion chamber 102 is obtained. A distance between the outer wall of the combustion chamber 102 and the inner wall of the combustion chamber 102 generally ranges from 4 mm to 10 mm.

Certainly, the distance between the defined position and the combustion chamber 102 is not limited to the foregoing embodiment, and may be selected by a person skilled in the art according to an actual requirement.

In an example, that a characterizing temperature characterizing a temperature in a combustion chamber 102 is obtained includes the following step. A characterizing temperature characterizing a temperature of an inner wall of the combustion chamber 102 is obtained. Generally, space in the combustion chamber 102 is limited. If the temperature sensor 111 is additionally arranged, the combustion is affected. Therefore, the temperature sensor 111 cannot be directly arranged in the combustion chamber 102. In other words, the temperature in the combustion chamber 102 cannot be directly measured. Therefore, in this example, the temperature in the combustion chamber 102 is indirectly obtained by obtaining the temperature at another position to characterize the temperature in the combustion chamber 102. When the characterizing temperature is converted into the temperature in the combustion chamber 102, the characterizing temperature may be converted by querying calibration data, or may be calculated and converted by combining a parameter such as a thermal conductivity.

Optionally, a temperature of the engine body 100 may be obtained through the temperature sensor 111 and used as the characterizing temperature. The characterizing temperature is close to the characterizing temperature of the combustion chamber 102, thereby enabling more accurate timing of fuel injection of the fuel and more sufficient spontaneous combustion of the fuel.

In this example, the engine body 100 may be provided with multiple temperature sensors 111. The multiple temperature sensors 111 obtain temperatures of different parts of the engine body 100 corresponding to the combustion chamber 102. An average value of the multiple temperatures is used as the characterizing temperature characterizing the temperature in the combustion chamber 102. In this way, the characterizing temperature characterizing the temperature in the combustion chamber 102 can be obtained more accurately.

In another example, a temperature at another position may also be obtained through the temperature sensor 111 and used as the characterizing temperature. For example, a temperature at a position at which an engine intake channel is close to the combustion chamber 102 is obtained and used as the characterizing temperature, or a temperature at a position at which an engine exhaust channel is close to the combustion chamber 102 is obtained and used as the characterizing temperature, or a dimension close to the fuel injection nozzle is obtained and used as the characterizing temperature.

In an example, the preset rule includes that the temperature in the combustion chamber 102 is greater than 300° C. In other words, when the temperature in the combustion chamber 102 is greater than or equal to the set threshold, the temperature in the combustion chamber 102 can reach a temperature above 300° C. during the compression stroke.

In an example, the preset rule includes that the temperature in the combustion chamber 102 is greater than 400° C. In other words, when the temperature in the combustion chamber 102 is greater than or equal to the set threshold, the temperature in the combustion chamber 102 can reach a temperature above 400° C. during the compression stroke.

Specifically, it may be determined according to an actual situation whether the temperature in the combustion chamber 102 meets the preset rule. Before the piston 104 reaches a top dead center, as the piston 104 moves, an air pressure in the combustion chamber 102 gradually increases. A higher pressure in the combustion chamber 102 indicates a lower combustion point. On the contrary, a lower pressure indicates a higher combustion point. A specific temperature value meeting the preset rule may be selected according to an actual situation, to ensure that the fuel spontaneously combusts in the combustion chamber 102. Generally, to ensure that the fuel can spontaneously combust in the combustion chamber 102, the temperature in the combustion chamber 102 needs to be greater than 300° C. In some operating conditions, the temperature in the combustion chamber 102 needs to be greater than 400° C., so that the fuel can spontaneously combust.

In an example, the preset rule includes that the temperature in the combustion chamber 102 is greater than the spontaneous combustion temperature of the fuel in the combustion chamber 102 in the current state.

The spontaneous combustion temperature is a minimum temperature at which the fuel can spontaneously combust in an aerobic atmosphere without a spark. It should be noted that the spontaneous combustion temperature is related to multiple factors, for example, a fuel injection speed, the air pressure in the combustion chamber 102, an oxygen content in the combustion chamber 102, and the type of the fuel. In this example, the temperature in the combustion chamber 102 is greater than the spontaneous combustion temperature of the fuel in the combustion chamber 102 in the current state, so that the fuel injected from the fuel injection system into the combustion chamber 102 can spontaneously combust without spark initiation.

In an example, the preset rule includes that the temperature in the combustion chamber 102 characterized by the characterizing temperature is greater than 1.2 times the spontaneous combustion temperature of the fuel in the combustion chamber 102. In other words, when the temperature in the combustion chamber 102 is greater than or equal to the set threshold, the temperature in the combustion chamber 102 can reach 1.2 times the spontaneous combustion temperature of the fuel during the compression stroke.

Under the condition, the control method can ensure that the fuel injected from the fuel injection system into the combustion chamber 102 rapidly combusts.

For example, if the spontaneous combustion temperature of the fuel is 300° C., the preset rule includes that the temperature characterized by the characterizing temperature in the combustion chamber 102 is greater than 360° C. In this way, it can be ensured that the fuel injected from the fuel injection system into the combustion chamber 102 can spontaneously combust rapidly.

For example, if the spontaneous combustion temperature of the fuel is 400° C., the preset rule includes that the temperature characterized by the characterizing temperature in the combustion chamber 102 is greater than 480° C. In this way, it can be ensured that the fuel injected from the fuel injection system into the combustion chamber 102 can spontaneously combust rapidly.

Certainly, ratio of the temperature in the combustion chamber 102 characterized by the characterizing temperature to the spontaneous combustion temperature included in the preset rule is not limited to the foregoing embodiment, and may be selected by a person skilled in the art according to an actual requirement.

In an example, the input parameter of the preset rule further includes a crank angle of the engine.

One rotation of the crank of the engine covers 360 degrees. According to the obtained crank angle, the fuel injection system can be effectively controlled to inject the fuel when the crank is rotated to a set crank angle. In this way, the control method can accurately control the timing of the fuel injection, so that the fuel can be heated for a sufficient time in the combustion chamber 102 and can spontaneously combust more sufficiently.

In an example, the preset rule includes that the crank angle of the engine ranges from 30° to 130° of a before top dead center of the compression stroke.

In a process in which the piston 104 moves from bottom dead center to top dead center, the crank rotates by 180°. In this example, the fuel injection is completed in a period of time starting from 50° of rotation of the crank from the bottom dead center to 150° of rotation of the crank. In other words, before the piston 104 reaches the top dead center, the fuel injection system already injects the fuel. In this way, the fuel is heated in the combustion chamber 102 for sufficient time, so that the fuel can combust when the piston 104 is near the top dead center.

It should be noted that the camshaft of the engine rotates synchronously with the crank. Therefore, to adjust the heating time of the combustion in the combustion chamber 102, the crank angle of the engine in this embodiment of the present disclosure may be equivalently replaced with phase information of the camshaft.

In an example, to enable the temperature in the combustion chamber 102 to reach the set threshold, the control method further includes that the combustion chamber 102 is heated. In this example, during the warm-up state, the temperature in the combustion chamber 102 can be heated to the set threshold.

In this example, the engine includes a heating apparatus. The heating apparatus may heat the combustion chamber 102 by means of electric heating or combustion heating. The heating apparatus heats the combustion chamber 102, so as to meet a temperature condition of the spontaneous combustion of the fuel. In other words, the engine is caused to complete the warm-up. After the heat, the temperature in the combustion chamber 102 allows the spontaneous combustion to occur when fuel is injected into the combustion chamber 102.

In an example, when the characterizing temperature is less than the set temperature, the combustion chamber 102 is heated. When the characterizing temperature is lower than the set temperature, the fuel injected into the combustion chamber 102 does not be spontaneously combust. When the characterizing temperature reaches or exceeds the set temperature, the fuel injected into the combustion chamber 102 can spontaneously combust.

For example, when the characterizing temperature is greater than or equal to the set temperature, the combustion chamber 102 is stopped heating. In other words, the warm-up of the engine is completed. The engine has a condition for switching from the warm-up state to the non-warm-up state. When the characterizing temperature is greater than or equal to the set temperature, the temperature in the combustion chamber is greater than or equal to the set threshold. The temperature in the combustion chamber 102 can reach the spontaneous combustion temperature of the fuel during the compression stroke.

In this example, when the characterizing temperature is greater than or equal to the set temperature, the combustion chamber 102 is stopped heating. Because the spontaneous combustion of the fuel generates heat, the heat may ensure that the characterizing temperature of the combustion chamber 102 is greater than or equal to the set temperature. In other words, the heat can cause the temperature in the combustion chamber 102 to always reach the spontaneous combustion temperature of the fuel during the compression stroke, so that the fuel spontaneously combusts.

Therefore, in this example, in the non-warm-up state, the characterizing temperature may no longer be obtained. In other words, during the second operating state, obtaining of the characterizing temperature is stopped, and the temperature in the combustion chamber 102 meets the preset rule by default. When the engine operates in the non-warm-up state, during the compression stroke, the fuel can be injected directly into the combustion chamber 102 because the temperature in the combustion chamber 102 can be always maintained by the heat of the spontaneous combustion of the fuel at a value that meets the preset rule. The fuel enters the combustion chamber 102 and is heated and spontaneously combust. Therefore, the control method for an engine in this embodiment of the present disclosure can be simplified, to ensure efficient operation of the engine.

Certainly, in this example, in the non-warm-up state, the characterizing temperature may still be obtained at a specific frequency. Therefore, in the non-warm-up state, the temperature in the combustion chamber 102 can be heated and raised in time when the temperature decreases, thereby ensuring the spontaneous combustion of the fuel. However, considering the heat generated when the fuel combusts, the frequency may be a relatively low value, to simplify the control method for an engine in this embodiment of the present disclosure to some extent.

In an example, that the combustion chamber 102 is heated includes the following step. The fuel is ignited through a spark plug 110, to heat the combustion chamber 102 by means of the heat of the fuel. In other words, in the warm-up state, to increase the temperature in the combustion chamber of the engine to the set threshold, the fuel may be ignited by the spark plug to heat the combustion chamber by means of the heat of the fuel.

In this example, the fuel is ignited through the spark plug 110. Heat is generated when the fuel combusts. The heat is used for heating the combustion chamber 102. In this manner, the spark plug 110 of an original engine is used to heat the combustion chamber 102. When the temperature in the combustion chamber 102 is greater than or equal to the set threshold, the fuel injected from the fuel injection system can spontaneously combust. When the acquired characterizing temperature reaches the set temperature, the spark plug 110 does not need to be started again. The temperature in the combustion chamber 102 is directly maintained by using the heat generated from combustion in the combustion chamber 102, so that the fuel injected into the combustion chamber 102 by the fuel injection system can spontaneously combust.

In this example, the heating manner of using the heat of the fuel to heat the combustion chamber 102 by igniting the fuel through the spark plug 110 is only applicable to heating the engine in the warm-up state of the engine. In the non-warm-up state, if the combustion chamber 102 needs to be heated by using the spark plug to ignite the fuel, control of the engine becomes complex. Different power and torques are outputted by different working cycles, which affects smoothness of operation of the engine.

In an example, that the combustion chamber 102 is heated includes the following step. The combustion chamber 102 is heated through an electric heating apparatus. To be specific, in the warm-up state or the non-warm-up state, to increase the temperature in the combustion chamber 102 of the engine to and above the set threshold, the combustion chamber 102 can be heated through the electric heating apparatus.

In this example, the engine body 100 is provided with the electric heating apparatus. The electric heating apparatus is configured to heat the combustion chamber 102. For example, the electric heating apparatus is arranged around the combustion chamber 102. The combustion chamber 102 is heated more rapidly through the electric heating apparatus. Performing heating through the electric heating apparatus can effectively control the temperature in the combustion chamber 102, which ensures that the fuel injected from the fuel injection system into the combustion chamber 102 can spontaneously combust.

For example, the electric heating apparatus includes a power supply, a switch, and a heating resistor. The power supply is electrically connected with the switch and the heating resistor. The power supply is configured to supply power to the heating resistor. The switch is configured to control on and off of a heating current. The electric heating apparatus can rapidly heat the combustion chamber 102. In another example, the electric heating apparatus includes a power supply and a switch. A cylinder configured to define the combustion chamber 102 is electrically connected with the power supply. The power supply is configured to supply power to the cylinder and directly heat the cylinder. The switch is configured to control on and off of a heating current.

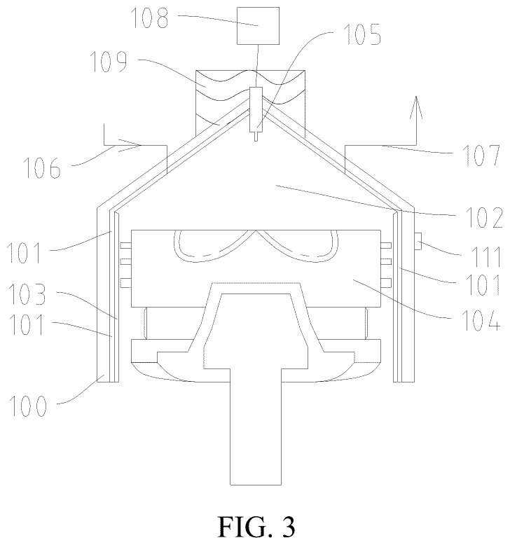

In an example, as shown in FIG. 3, the engine body 100 includes a cylinder liner 103. The cylinder liner 103 is arranged in the cylinder 101. An outer wall of the cylinder liner 103 is attached to an inner wall of the cylinder 101. The piston 104 is located in the cylinder liner 103. A material of the cylinder liner 103 is harder than a material of the inner wall of the cylinder 101, and has good wear resistance. The cylinder liner 103 can effectively improve a service life of the engine. In an example, the electric heating apparatus includes an electric heating unit. The electric heating unit is arranged between the inner wall of the cylinder 101 and the cylinder liner 103. The electric heating unit heats the combustion chamber 102, so that the temperature in the combustion chamber 102 is maintained at a temperature above the spontaneous combustion temperature of the fuel. Arranging the electric heating unit between the inner wall of the cylinder 101 and the cylinder liner 103 can avoid impact of an external force, thereby significantly improving durability of the engine.

The electric heating apparatus can operate and maintain the temperature of the combustion chamber to rise when the temperature in the combustion chamber drops unexpectedly in the non-warm-up stage of the engine. The electric heating apparatus can further heat the combustion chamber 102 in the warm-up stage of the engine, so that the characterizing temperature reaches the set temperature.

In an example, that a fuel injection system is controlled to inject fuel into the combustion chamber 102 includes the following step. The fuel is injected into the combustion chamber 102 multiple times.

Compared with injecting the fuel a single time, injecting the fuel into the combustion chamber 102 multiple times after the obtained characterizing temperature reaches the set temperature can cause the fuel to be mixed with the air more sufficiently, so that the injected fuel can spontaneously combust rapidly. In this way, a starting speed of the engine can be significantly increased.

In an example, before the fuel injection system is controlled to inject the fuel into the combustion chamber 102 according to the preset rule, the method includes the following step. When the engine is in an intake stroke or a compression stroke, the fuel injection system is controlled to inject a first set amount of fuel into the combustion chamber 102.

That a fuel injection system is controlled to inject fuel into the combustion chamber 102 according to the preset rule includes the following step. The fuel injection system is controlled to inject a second set amount of fuel into the combustion chamber 102. The second set amount is greater than the first set amount.

In a specific embodiment, when the engine is in the intake stroke, fuel pre-injection is performed, i.e., the first set amount of fuel is injected. When the engine is in the compression stroke, main fuel injection is performed, i.e., the second set amount of fuel is injected. An amount of the pre-injected fuel is less than an amount of the main injected fuel. Specifically, when the engine is in the intake stroke, the fuel injection system is controlled to inject the first set amount of fuel into the combustion chamber 102. In this case, the first set amount is the amount of the pre-injected fuel. The first set amount is relatively small. Therefore, a spontaneous combustion condition is far from being met after the first set amount of fuel is thinned in the combustion chamber. In this case, the pre-injected fuel does not spontaneously combust. However, the pre-injected fuel can be sufficiently mixed with the air, so that the main injected fuel can be rapidly and sufficiently mixed with a gas mixture in the combustion chamber 102. When the engine is in the compression stroke, the fuel injection system is controlled to inject the second set amount of fuel into the combustion chamber 102. In this case, the second set amount is the amount of the main injected fuel. Because the characterizing temperature reaches the set temperature, the fuel spontaneously combusts in the combustion chamber 102 after the main injection.

In another specific embodiment, when the engine is in the compression stroke, fuel pre-injection is performed and then main fuel injection is performed. An amount of the pre-injected fuel is less than an amount of the main injected fuel. Specifically, when the engine is in the compression stroke, the fuel injection system is controlled to inject the first set amount of fuel into the combustion chamber 102. In this case, the first set amount is the amount of the pre-injected fuel. The first set amount is relatively small. A spontaneous combustion condition is far from being met after the first set amount of fuel is thinned in the combustion chamber. However, the pre-injected fuel can be sufficiently mixed with the air, so that the main injected fuel can be rapidly and sufficiently mixed with a gas mixture in the combustion chamber 102. Next, the fuel injection system is controlled to inject the second set amount of fuel into the combustion chamber 102. In this case, the second set amount is the amount of the main injected fuel. Because the characterizing temperature reaches the set temperature, the fuel spontaneously combusts in the combustion chamber 102 after the main injection.

In this example, the pre-injected fuel can be rapidly mixed with the air. The main injected fuel can be rapidly and sufficiently mixed with the gas mixture in the combustion chamber 102, so as to achieve an objective of rapid combustion and avoid a knock.

According to another embodiment of the present disclosure, an engine is provided. The engine is applied to an automobile, a ship, an airplane, a compression machine, a construction machinery, or the like.

As shown in FIG. 1, the engine includes an engine body 100, a fuel injection system, a piston 104, and a control apparatus 108. A cylinder 101 is formed in the engine body 100. The piston 104 is slidably arranged in the cylinder 101. A combustion chamber 102 is formed between the piston 104 and an inner wall of the cylinder 101. The fuel injection system is in communication with the combustion chamber 102 and is configured to inject fuel into the combustion chamber 102.

The control apparatus 108 is configured to: obtain a characterizing temperature characterizing a temperature in a combustion chamber 102; and control, according to a preset rule, a fuel injection system to inject fuel into the combustion chamber 102 when an engine is in a compression stroke, the fuel in the combustion chamber 102 being heated and spontaneously combusting, and an input parameter of the preset rule including the characterizing temperature.

When applied to a vehicle, the control apparatus may be a whole vehicle controller, or may be a controller of an engine.

Specifically, the engine further includes an intake system 106, an exhaust system 107, and a temperature sensor 111 configured to collect the characterizing temperature. The intake system 106 and exhaust system 107 are arranged on the engine body 100. The intake system 106 and the exhaust system are both in communication with the combustion chamber 102. The temperature sensor 111 is arranged on the engine body 100. The temperature sensor 111 is configured to sense a temperature at a defined position of the engine body 100. The control apparatus 108 is in signal connection with the sensor. The temperature sensor 111 is configured to sense the characterizing temperature characterizing the temperature in the combustion chamber 102. The piston 104 is connected to the crank through a connecting rod. The control apparatus 108 controls the fuel injection system to inject fuel into the combustion chamber 102 when the engine is in the compression stroke according to the preset rule, so that the fuel is heated and spontaneously combusts.

In this embodiment of the present disclosure, the engine obtains the characterizing temperature characterizing the temperature in the combustion chamber 102 through the control apparatus 108. During a compression stroke, when the characterizing temperature reaches a set value, the fuel injection system is controlled to inject the fuel into the combustion chamber 102, thereby causing the fuel to spontaneously combust. The engine can accurately control the fuel injection system to inject the fuel, thereby ensuring that the fuel sufficiently combusts.

During actual operation of the engine, the engine in this embodiment of the present disclosure has a first operating state and a second operating state between which the engine can be switched. The control apparatus is configured to: increase the temperature in the combustion chamber 102 of the engine to the set threshold during the first operating state, when the temperature in the combustion chamber 102 is greater than or equal to the set threshold, the temperature in the combustion chamber 102 reaching the spontaneous combustion temperature of the fuel during the compression stroke; and inject the fuel into the combustion chamber 102 during the second operating state, so that the fuel is heated and spontaneously combusts in the combustion chamber 102.

That a characterizing temperature characterizing a temperature in a combustion chamber 102 is obtained may be performed during the first operating state or during the second operating state. When the engine is in the compression stroke, the fuel injection system is controlled to inject the fuel into the combustion chamber 102 according to the preset rule. The fuel in the combustion chamber 102 is heated and spontaneously combusts, which occurs during the second operating state.

In addition, before the engine injects the fuel into the combustion chamber 102 by the fuel injection system, the temperature in the combustion chamber 102 reaches the set threshold. Combustion is performed in a manner of the spontaneous combustion of the fuel, which avoids the risk of knock compared with the manner of ignition by the spark plug 110.

In an example, the compression ratio of the engine is greater than 15. The compression ratio of the engine characterizes a degree to which the gas mixture of the engine is compressed. For example, the compression ratio of the engine is a ratio of a total volume of the cylinder 101 before compression to a volume of the cylinder 101 after compression. The gas mixture includes fuel and air.

In this example, the compression ratio of the engine is greater than 15. A larger compression ratio indicates a higher degree of compression of the gas mixture. A larger gas pressure of the gas mixture indicates a lower spontaneous combustion temperature of the fuel. Under the condition, the spontaneous combustion of the fuel requires a low temperature. The combustion chamber 102 has a shorter heating time. The spontaneous combustion is more sufficient. The combustion of the fuel is achieved through the spontaneous combustion, which reduces the risk of knock of the engine. Therefore, the compression ratio of the engine in this embodiment can be made larger, even up to 18 or 20 or more.

In an example, that a characterizing temperature characterizing a temperature in a combustion chamber 102 is obtained includes the following step. A temperature at a defined position in the engine body 100 is obtained. A distance between the defined position and the combustion chamber 102 ranges from 4 mm to 10 mm. Specifically, the temperature of the defined position is used as the characterizing temperature.

The distance between the defined position and the combustion chamber is a minimum distance between the defined position and an inner wall of the combustion chamber.

The temperature sensor 111 is arranged at a defined position of the engine body 100. In other words, the temperature sensor is arranged on the engine body. A defined position closer to the combustion chamber 102 indicates a temperature sensed by the temperature sensor 111 closer to the temperature in the combustion chamber 102. In the foregoing size range, high structural strength of the inner wall of the combustion chamber 102 can be ensured, and the characterizing temperature obtained by the temperature sensor 111 is closer to the temperature in the combustion chamber 102.

Certainly, the distance between the defined position and the combustion chamber 102 is not limited to the foregoing embodiment, and may be selected by a person skilled in the art according to an actual requirement. In an embodiment in which the cooling water jacket is removed, the defined position may be set at a position other than 10 mm away from the combustion chamber 102. When improvement is performed according to an existing engine, positions of a cylinder body and a cylinder cover that are originally used for arranging the water jacket may be used as defined positions, and a temperature sensor 111 is correspondingly arranged.

In an example, the distance between the defined position and the combustion chamber 102 ranges from 4 mm to 10 mm. The temperature of the defined position is greater than 150° C.

A larger distance between a position of temperature measurement and the combustion chamber 102 indicates a lower accuracy of a sensed characterizing temperature in characterizing the temperature in the combustion chamber 102. On the contrary, a smaller distance indicates a higher accuracy of a sensed characterizing temperature in characterizing the temperature in the combustion chamber 102. Within the foregoing size range, the obtained characterizing temperature can well characterize the temperature in the combustion chamber 102.

In an example, the distance between the defined position and the combustion chamber 102 ranges from 4 mm to 10 mm. The temperature of the defined position is greater than 200° C.

In an example, to enable the temperature in the combustion chamber to be maintained at the set threshold, the engine further includes a heat preservation apparatus. The heat preservation apparatus is arranged in the engine body 100. The heat preservation apparatus is configured to perform heat preservation on the combustion chamber 102.

Specifically, an amount of heat radiated from the combustion chamber 102 outward may be reduced by arranged a thermal insulation coating 113 inside the combustion chamber 102, or the cooling water jacket outside the combustion chamber 102 is removed or a cooling effect of the cooling water jacket is reduced, to reduce the heat radiated from the combustion chamber 102, or a heat preservation structure is arranged outside the combustion chamber.

The heat preservation apparatus can effectively prevent the temperature in the combustion chamber 102 from being dispersed, so that the temperature in the combustion chamber 102 is maintained at a temperature above the spontaneous combustion temperature of the fuel. In this way, it can be effectively ensured that the fuel injected into the combustion chamber 102 spontaneously combusts rapidly and sufficiently. In other words, compared with the engine in the related art, the engine in this embodiment of the present disclosure eliminates a cooling structure such as the cooling water jacket, and additionally arrange the heat preservation apparatus.

In addition, the heat preservation apparatus reduces dissipation of the heat of the fuel, which significantly improves the thermal efficiency of the engine. Specifically, after the heat preservation apparatus is arranged, the temperature of an exhaust gas of the combustion chamber significantly increases. One or more exhaust gas utilization apparatuses may be arranged on an exhaust side of the engine, to improve a utilization rate of heat, thereby improving the thermal efficiency of the engine.

In an example, the heat preservation apparatus includes the heat preservation structure. A thermal insulation chamber is formed in the heat preservation structure. The heat preservation structure is arranged on an outer side of the cylinder 101 and around the cylinder 101.

For example, a position in the related art at which the engine is originally configured to arrange a cylinder body water jacket may be used as the heat preservation structure in this example. A cavity structure at the position is used as the thermal insulation chamber. In some examples, a heat preservation material may be filled in the thermal insulation chamber, to further improve a heat preservation effect.

For example, a hollow chamber is arranged on the engine body 100. The hollow chamber constitutes the thermal insulation chamber. The thermal insulation chamber can effectively isolate the combustion chamber 102.

Optionally, a heat preservation cotton may be arranged in the thermal insulation chamber. The heat preservation cotton can effectively perform an insulation function.

Alternatively, the thermal insulation chamber may be evacuated, so as to maintain a set level of vacancy in the thermal insulation chamber. The evacuated thermal insulation chamber can achieve a heat preservation function, so that the combustion chamber 102 can be effectively insulated.

Certainly, the heat preservation structure is not limited to the foregoing embodiment, which may be arranged by a person skilled in the art according to an actual requirement.

In an example, the heat preservation apparatus includes a thermal insulation coating 113. The thermal insulation coating 113 is arranged on the inner wall of the cylinder 101, or arranged on the outer side of the cylinder 101 and around the cylinder 101, or arranged on an end of the piston 104.

The thermal insulation coating 113 is configured to prevent the heat in the combustion chamber 102 from diffusing outward. For example, the thermal insulation coating 113 is made of porous anodic alumina. The porous anodic alumina is an aluminum oxide material prepared through anodizing of aluminum metal in an acidic condition. The material has a good thermal insulation effect. For example, the thermal insulation coating 113 is formed on the engine body, the cylinder, the cylinder liner, or an exhaust pipe through a powder metallurgy process.

Optionally, the thermal insulation coating 113 is made of a silicon dioxide reinforced porous anodic alumina. A silica coating with a micron thickness is formed on a surface of the porous anodic alumina. The silica coating can effectively improve wear resistance of the porous anodic alumina. The material has a characteristic of excellent thermal insulation performance, which can effectively prevent the heat of the engine from diffusing outward.

Certainly, the material of the thermal insulation coating 113 is not limited to the foregoing embodiment, and may be selected by a person skilled in the art according to an actual requirement.

A larger thickness of the thermal insulation coating 113 indicates a better thermal insulation effect. However, a larger thickness may cause the thermal insulation coating 113 to easily fall off from the engine body 100. Optionally, a thickness of the thermal insulation coating 113 ranges from 10 μm to 100 μm. Within the range, the thermal insulation coating 113 can effectively prevent the heat in the combustion chamber 102 from diffusing outward, and the thermal insulation coating 113 has a high connection strength with the engine body 100.

The thermal insulation coating 113 is attached to the inner wall of the cylinder 101, or the thermal insulation coating 113 is located on the engine body 100 and arranged around the cylinder 101. The thermal insulation coating 113 has a good thermal insulation effect at the foregoing position.

Alternatively, the thermal insulation coating 113 is arranged on an end of the piston 104. In this example, the thermal insulation coating 113 located on the end of the piston 104 effectively prevents the heat from diffusing outward through the piston 104.

In a specific example, the thermal insulation coating 113 is attached to an original cooling water jacket of the engine body 100. The cooling water jacket is arranged around the combustion chamber 102. The thermal insulation coating 113 is arranged on an inner wall of the cooling water jacket. The thermal insulation coating 113 can provide a good thermal insulation function.

In an example, as shown in FIG. 3, the engine body 100 includes a cylinder liner 103. The cylinder liner 103 is arranged in the cylinder 101. An outer wall of the cylinder liner 103 is attached to an inner wall of the cylinder 101. The piston 104 is located in the cylinder liner 103.

A material of the cylinder liner 103 is harder than a material of the inner wall of the cylinder 101, and has good wear resistance. The cylinder liner 103 can effectively improve a service life of the engine.

In an example, the engine further includes a heat preservation apparatus. The heat preservation apparatus is arranged in the engine body 100. The heat preservation apparatus is configured to perform heat preservation on the combustion chamber 102. The heat preservation apparatus includes the thermal insulation coating 113. The thermal insulation coating 113 is arranged between the inner wall of the cylinder 101 and the cylinder liner 103, or the thermal insulation coating 113 is arranged on the inner wall of the cylinder liner 103.

For example, the material and the thickness of the thermal insulation coating 113 are as described above. The thermal insulation coating 113 is arranged on at least one of the outer wall of the cylinder liner 103 and the inner wall of the cylinder 101. The thermal insulation coating 113 can effectively perform a thermal insulation function. In addition, the thermal insulation coating 113 at the position is less susceptible to an external impact, and has good durability.

Alternatively, the thermal insulation coating 113 is arranged on the inner wall of the cylinder liner. The thermal insulation coating 113 at this position is closer to the combustion chamber 102, and therefore, can achieve a more effective heat retention function.

In an example, the engine further includes a cooling apparatus 109. The cooling apparatus 109 is arranged in the engine body 100. The cooling system is configured to cool the fuel injection system.

For example, the cooling apparatus 109 includes a cooling pipeline and a circulation pump. The fuel injection system includes a fuel injection nozzle 105. The cooling pipeline is arranged around the fuel injection nozzle 105. The circulation pump is in communication with the cooling pipeline. A coolant is introduced into the cooling pipeline by the circulation pump, and the heated coolant is delivered to a cold end, to cool the fuel injection nozzle 105. For example, the coolant is water, a silicon oil, or the like.

An excessively high temperature of the fuel injection system may cause coking of the fuel at the fuel injection nozzle 105, and further block the fuel injection nozzle 105. The cooling apparatus 109 can effectively cool the fuel injection nozzle 105, to avoid coking of the fuel, thereby ensuring a normal operation of the fuel injection system.

Certainly, the cooling apparatus 109 is not limited to the foregoing embodiment, which may be arranged by a person skilled in the art according to an actual requirement.

According to another embodiment of the present disclosure, a vehicle is provided. The vehicle includes a vehicle body and the foregoing engine. The engine is arranged on the vehicle body.

The vehicle has characteristics of a rapid engine startup, a low vibration, and a high thermal efficiency.

According to still another embodiment of the present disclosure, the present disclosure may be a system, a method, and/or a computer program product. The computer program product may include a computer-readable storage medium. When the computer instruction is executed by the processor, the control method for an engine of the present disclosure is performed.

The computer-readable storage medium may be a tangible device that may hold and store instructions used by an instruction execution device. For example, the computer-readable storage medium may be but is not limited to, an electrical storage device, a magnetic storage device, an optical storage device, an electromagnetic storage device, a semiconductor storage device, or any appropriate combination thereof. More specific examples (a non-exhaustive list) of the computer-readable storage medium include: a portable computer disk, a hard disk, a random access memory (RAM), a read-only memory (ROM), an erasable programmable ROM (EPROM or a flash memory), a static RAM (SRAM), a portable compact disk ROM (CD-ROM), a digital versatile disc (DVD), a memory stick, a floppy disk, a mechanical encoding device, for example, a punched card having instructions stored thereon or a protrusion structure in a groove, and any appropriate combination thereof. The computer-readable storage medium used herein is not construed as an instantaneous signal, for example, a radio wave or another freely propagating electromagnetic wave, an electromagnetic wave propagating through a waveguide or another transmission medium (for example, an optical pulse passing through an optical fiber cable), or an electric signal transmitted through an electric wire.

The computer-readable program instructions described herein may be downloaded from the computer-readable storage medium to each computing/processing device, or downloaded to an external computer or an external storage device through a network such as the Internet, a local area network (LAN), a wide area network (WAN), and/or a wireless network. The network may include a copper transmission cable, optical fiber transmission, wireless transmission, a router, a firewall, a switch, a gateway computer, and/or an edge server. A network adapter card or a network interface in each computing/processing device receives computer-readable program instructions from the network, and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or target code written in any combination of one or more programming languages. The programming languages include an object-oriented programming language such as Smalltalk or C++, and a conventional procedural programming language such as C programming language or a similar programming language. The computer-readable program instructions may be completely executed on a user computer, partially executed on the user computer, executed as an independent software package, partially executed on the user computer and partially executed on a remote computer, or completely executed on a remote computer or a server. In a situation involving the remote computer, the remote computer may be connected to the user computer through any type of network including a LAN or a WAN, or may be connected to an external computer (for example, connected to the external computer through the Internet by using an Internet service provider). In some embodiments, an electronic circuit is personalized and customized through state information of the computer-readable program instructions, for example, a programmable logic circuit, a field programmable gate array (FPGA), or a programmable logic array (PLA). The electronic circuit may execute the computer-readable program instructions, thereby implementing all aspects of the present disclosure.

All of the aspects of the present disclosure are described herein with reference to the flowcharts and/or the block diagrams of the method, the apparatus (system), and the computer program product in the embodiments of the present disclosure. It should be understood that each block in the flowcharts and/or the block diagrams and a combination of the blocks in the flowcharts and/or the block diagrams may be both implemented through the computer-readable program instructions.

The computer-readable program instructions may be provided to a general-purpose computer, a dedicated computer, or a processor of another programmable data processing apparatus, to produce a machine. In this way, the instructions, when executed through the computer or the processor of the another programmable data processing apparatus, generate an apparatus that implements the functions/actions specified in one or more blocks in the flowcharts and/or the block diagrams. The computer-readable program instructions may alternatively be stored in the computer-readable storage medium. The instructions cause the computer, the programmable data processing apparatus, and/or another device to operate in a specific manner. Therefore, the computer-readable medium storing the instructions includes a manufactured product, which includes instructions for implementing all aspects of the functions/actions specified in one or more blocks in the flowcharts and/or the block diagrams.

The computer-readable program instructions may alternatively be loaded to the computer, the another programmable data processing apparatus, or the another device, so that a series of operations and steps are performed on the computer, the another programmable data processing apparatus, or the another device, to generate a process of computer implementation. In this way, the instructions executed on the computer, the another programmable data processing apparatus, or the another device implement the functions/actions specified in one or more blocks in the flowcharts and/or the block diagrams.

The flowcharts and block diagrams in the accompanying drawings show a system architecture, functions, and operations that may be implemented by using the system, the method, and the computer program product according to multiple embodiments of the present disclosure. In this regard, each block in the flowcharts or the block diagrams may represent a module, a program segment, or a part of an instruction. The module, the program segment, or the part of the instruction includes one or more executable instructions for implementing a specified logic function. In some alternative implementations, functions annotated in the blocks may also be performed in an order different from that annotated in the drawings. For example, two consecutive blocks may be executed in parallel, or may sometimes be executed in reverse order, which depends on the functions involved. It should also be noted that each box of the block diagrams and/or the flowcharts and combinations of boxes in the block diagrams and/or the flowcharts may be implemented by a dedicated hardware-based system that performs specified functions or actions, or may be implemented by a combination of dedicated hardware and a computer instruction. It is well-known to a person skilled in the art that implementations through hardware, software, and a combination of software and hardware are all equivalent.

The embodiments of the present disclosure have been described above, and the above description is exemplary, non-exhaustive, and is not limited to the disclosed embodiments. Without departing from the scope and the spirit of the various embodiments described, many modifications and changes are apparent to a person of ordinary skill in the art. The selection of the terms used herein is intended to be the best explanation of the principles, practical applications of the various embodiments, or technical improvements of the technology in the market, or to enable others of ordinary skill in the art to understand the embodiments disclosed herein. The scope of the present disclosure is limited only by the appended claims.

What is claimed is:

1. A control method for an engine, comprising:
obtaining a characterizing temperature characterizing a temperature in a combustion chamber; and
controlling, according to a preset rule, a fuel injection system to inject fuel into the combustion chamber when an engine is in a compression stroke, the fuel in the combustion chamber being heated and spontaneously combusting, and an input parameter of the preset rule comprising the characterizing temperature.

2. The control method for an engine according to claim 1, wherein the obtaining a characterizing temperature characterizing a temperature in a combustion chamber comprises: obtaining a temperature at a defined position in an engine body of the engine, a distance between the defined position and the combustion chamber ranging from 4 mm to 10 mm.

3. The control method for an engine according to claim 1, wherein the obtaining a characterizing temperature characterizing a temperature in a combustion chamber comprises: obtaining a characterizing temperature characterizing a temperature of an inner wall of the combustion chamber.

4. The control method for an engine according to claim 1, wherein the preset rule comprises that the temperature in the combustion chamber is greater than 300° C.

5. The control method for an engine according to claim 1, wherein the preset rule comprises that the temperature in the combustion chamber is greater than 400° C.

6. The control method for an engine according to claim 1, wherein the preset rule comprises that the temperature in the combustion chamber is greater than a spontaneous combustion temperature of the fuel in the combustion chamber in a current state.

7. The control method for an engine according to claim 1, wherein the preset rule comprises that the temperature in the combustion chamber characterized by the characterizing temperature is greater than 1.2 times the spontaneous combustion temperature of the fuel in the combustion chamber.

8. The control method for an engine according to claim 1, wherein the input parameter of the preset rule further comprises a crank angle of the engine.

9. The control method for an engine according to claim 8, wherein the preset rule comprises that the crank angle of the engine ranges from 30° to 130° of a before top dead center of the compression stroke.

10. The control method for an engine according to claim 1, wherein the input parameter of the preset rule further comprises at least one of a compression ratio of the engine, the crank angle of the engine, a camshaft phase of the engine, a rotation speed of the engine, a pressure value in the combustion chamber, a fuel injection pressure of the fuel injection system, an intake air flow of the combustion chamber, an amount of fuel injected from the combustion chamber, and a type of the fuel.

11. The control method for an engine according to claim 1, wherein
the combustion chamber is heated when the characterizing temperature is less than a set temperature; and
the heating of the combustion chamber is stopped when the characterizing temperature is greater than or equal to the set temperature, wherein when the characterizing temperature is greater than or equal to the set temperature, the temperature in the combustion chamber reaches the spontaneous combustion temperature of the fuel during the compression stroke.

12. The control method for an engine according to claim 11, wherein the heating the combustion chamber comprises: igniting the fuel through a spark plug, to heat the combustion chamber through heat of the fuel; or heating the combustion chamber through an electric heating apparatus.

13. A computer-readable storage medium, storing computer instructions, the computer instructions, when executed by a processor, performing the control method for an engine according to claim 1.

14. An engine, comprising an engine body, a fuel injection system, a piston, and a control apparatus, a cylinder being formed in the engine body, the piston being slidably arranged in the cylinder, a combustion chamber being formed between the piston and an inner wall of the cylinder, and the fuel injection system being connected with the combustion chamber and configured to inject fuel into the combustion chamber;
the control apparatus being configured to:
obtain a characterizing temperature characterizing a temperature in a combustion chamber; and
control, according to a preset rule, a fuel injection system to inject fuel into the combustion chamber when an engine is in a compression stroke, the fuel in the combustion chamber being heated and spontaneously combusting, and an input parameter of the preset rule comprising the characterizing temperature.

15. The engine according to claim 14, wherein the compression ratio of the engine is greater than 15.

16. The engine according to claim 14, wherein the obtaining a characterizing temperature characterizing a temperature in a combustion chamber comprises: obtaining a temperature at a defined position in the engine body, a distance between the defined position and the combustion chamber ranging from 4 mm to 10 mm; and the temperature of the defined position is greater than 150° C.

17. The engine according to claim 16, further comprising a temperature sensor configured to obtain the characterizing temperature, the temperature sensor being arranged on the engine body; and a heat preservation apparatus, the heat preservation apparatus being arranged on the engine body, and the heat preservation apparatus being configured to perform heat preservation on the combustion chamber, wherein the heat preservation apparatus comprises:
a heat preservation structure, a thermal insulation chamber being formed in the heat preservation structure, the heat preservation structure being arranged on an outer side of the cylinder and around the cylinder.

18. The engine according to claim 17, wherein the heat preservation apparatus comprises:
a thermal insulation coating, the thermal insulation coating being arranged on the inner wall of the cylinder, or arranged on the outer side of the cylinder and around the cylinder, or arranged on an end of the piston.

19. The engine according to claim 14, wherein:
the engine body comprises a cylinder liner; the cylinder liner is arranged in the cylinder; an outer wall of the cylinder liner is attached to the inner wall of the cylinder; and the piston is located in the cylinder liner;
the engine further comprises a heat preservation apparatus, the heat preservation apparatus being arranged on the engine body, the heat preservation apparatus being configured to perform heat preservation on the combustion chamber, and the heat preservation apparatus comprising a thermal insulation coating, the thermal insulation coating being arranged between the inner wall of the cylinder and the cylinder liner, or the thermal insulation coating being arranged on an inner wall of the cylinder liner; and
the engine further comprises a heating apparatus, the heating apparatus being connected with the control apparatus, the heating apparatus comprising an electric heating unit, and the electric heating unit being arranged between the inner wall of the cylinder and the outer wall of the cylinder liner.

20. A vehicle, comprising a vehicle body and the engine according to claim 14, the engine being arranged on the vehicle body.
